(19) United States
(12) Patent Application Publication
(10) Pub. No.: US 2014/0274249 A1
(43) Pub. Date: Sep. 18, 2014

(54) Gaming System and Methods of Playing a Baccarat-Type Game Having a Side Wager

(71) Applicant: James T. Kenny, Shorewood, IL (US)

(72) Inventor: James T. Kenny, Shorewood, IL (US)

(21) Appl. No.: 13/800,171

(22) Filed: Mar. 13, 2013

(51) Int. Cl. G07F 17/32; A63F 3/00; A63F 1/00

(52) U.S. Cl. CPC G07F 17/3293; A63F 1/00; A63F 3/00157
USPC 463/11; 273/292

(57) ABSTRACT

A method of providing a wagering game is described herein. The method includes providing one or more decks of randomly-ordered physical playing cards, receiving a side wager from a player, and distributing a plurality of playing cards at the gaming table from one or more decks of playing cards. Each playing card of the plurality of playing cards has an associated pip status. The plurality of distributed playing cards includes a predefined set of playing cards. The method also includes detecting a winning condition in the plurality of distributed playing cards, wherein the winning condition is defined as each playing card of the predefined set of playing cards having a predefined pip status.

### TECHNICAL FIELD

The subject matter disclosed herein relates generally to gaming systems and more particularly, to a system and method for allowing players to play a baccarat-type game having a side wager.

### BACKGROUND OF THE INVENTION

At least some known gaming machines display baccarat-type games that include a plurality of playing cards that are distributed in a Player hand and a Banker hand. During play of known baccarat games, a player selects the Player hand or the Banker hand to be the winning hand, or selects a tie result, and places a wager associated with the selected outcome. The gaming machine then deals a plurality of cards to the Player hand and the Banker hand. After the gaming machine has complete the deal, the gaming machine determines a value of the Player hand and the Banker hand, and determines the result of the Baccarat game as one of the Player hand winning, the Banker hand winning, or a tie result.

Over time, during game play, the player may become frustrated because the chances of receiving an award are based only on the values of the Player hand and the Banker hand. Accordingly, new features are necessary to appeal to player interest and enhance excitement in order to entice longer play and increased profitability. The present invention is directed to satisfying these needs.

### SUMMARY OF THE INVENTION

In one aspect of the present invention, a method of providing a wagering game at a gaming table is provided. The method includes displaying, on the gaming table, one or more wagering areas and indicia relating to associated wagering opportunities, providing one or more decks of randomly-ordered physical playing cards, receiving a side wager from a player, and distributing a plurality of playing cards at the gaming table from the one or more decks of playing cards. Each playing card of the plurality of playing cards having an associated pip status. The plurality of distributed playing cards includes a predefined set of playing cards. The method also includes detecting a winning condition in the plurality of distributed playing cards, wherein the winning condition is defined as each playing card of the predefined set of playing cards having a predefined pip status. The method includes settling the wager received from the player by either awarding a payout amount to the player in response to detecting the winning condition or collecting the wager.

In another aspect of the present invention, a system for providing a wagering type game is provided. The system includes a display device, a user input device configured to generate a signal indicative of a player selection input, and a controller coupled to the display device and the user input device. The controller receives a signal indicative of a wager from a player and responsively displays the wagering type game on the display device. The controller randomly selects a plurality of playing cards including a predefined set of playing cards. Each playing card of the plurality of playing cards having an associated pip status. The controller distributes a first hand and a second hand, wherein each first hand and second hand includes one or more playing cards from the plurality of playing cards. The controller detects a winning condition in the plurality of distributed playing cards and responsively settles the wager received from the player by either awarding a payout amount to the player in response to detecting the winning condition or collecting the wager. The winning condition is defined as each playing card of the predefined set of playing cards having a predefined pip status.

In yet another aspect of the present invention, a computer-implemented method of providing a wagering game is provided. The method includes one or more processors, communication devices, and data storage devices, all for facilitating the steps of receiving from a communication device, a signal indicative of wager from a player, generating, by a processor, the wagering game in response to the received wager and displaying the wagering game on a display device, and randomly selecting a plurality of playing cards. Each playing card of the plurality of playing cards having an associated pip status. The method also includes determining a predefined set of playing cards from the plurality of selected playing cards, distributing a first hand including one or more playing cards from the plurality of playing cards, distributing a second hand including one or more playing cards from the plurality of playing cards, and detecting a winning condition in the plurality of distributed playing cards. The method includes settling the wager received from the player by either awarding a payout amount to the player in response to detecting the winning condition or collecting the wager. The winning condition being defined as each playing card of the predefined set of playing cards having a predefined pip status.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic view of gaming apparatus that may be used to play a baccarat-type game, according to an embodiment of the present invention;

FIG. 2 is a flowchart of a method of allowing a player to play the baccarat-type game that may be used with the gaming apparatus shown in FIG. 1;

FIG. 3 is graphic illustration of playing cards that may be used with the baccarat-type game, according to an embodiment of the present invention;

FIG. 4 is a graphic illustration of a suit of playing cards that may be used with the baccarat-type game, according to an embodiment of the present invention;

FIG. 5 is a schematic view an exemplary gaming system of the present invention;

FIG. 6 is a graphical display of a baccarat-type game that may be played with the gaming system shown in FIG. 6, according to an embodiment of the present invention; and

FIG. 7 is a schematic diagram of another embodiment of the gaming system shown in FIG. 5, according to an embodiment of the present invention.

Corresponding reference characters indicate corresponding parts throughout the drawings.

### DETAILED DESCRIPTION OF THE PREFERRED EMBODIMENT

The exemplary embodiments herein relate to wagering games. It should be understood that each of the methods and individual steps recited herein may be partially or wholly carried out in a variety of ways and/or systems, which may include, but are not limited to, a live dealer physically dealing playing cards in a casino, an electronic gaming machine (EGM) for use by one or more players, a multiplayer platform which may include a player interface such as a touchscreen display and involve physical or virtual playing cards, dealer and wagering chips, a home computer or portable computing device, such as a tablet computer or mobile phone capable of communicating with a network or over the Internet, global telecommunication network or world wide web.

It should further be understood that the invention is directed to, among other things, methods of providing, conducting and resolving wagering games that include a sequence of controlled and concrete transformative events. Some of these events may involve wagering, the generation of random data, the application of randomly-generated data to predefined rules, the determination of wager outcomes in accordance with preset outcome determining criteria, the notification of such outcomes, awarding of payouts and collecting of wagers. The generation of random data may be facilitated by computerized and/or physical implements. The transformative events may also include parsing of the data for comparative purposes with preset criteria to determine an outcome in a second, bonus or associated wagering game.

With reference to the drawings and in operation, the present invention overcomes at least some of the disadvantages of known gaming machines by providing a gaming system than allows a player to place a side-wager on a baccarat-type game, distributes a plurality of cards to a Player hand and a Banker hand, and determines a winning condition based on the status of pip symbols displayed in a predefined set of the distributed cards. More specifically, the gaming system distributes the Player hand and the Banker hand including a plurality of cards that each have an associated pip status. The gaming system selects a set of cards from the plurality of cards, determines the pip status of each card in the set of playing cards, and provides an award to the player if each playing card in the set of playing cards has a predefined pip status. By providing a gaming system that provides an award to a player based on the pip status of the distributed playing cards, the player's expectation for achieving a win is increased and the enjoyment of the game is improved. Thus, the amount of time that the game is played by patrons of a gaming establishment is thereby increased.

In general, the gaming system 10 allows a player to initiate a gaming session to play a baccarat-type game via the gaming system 10. The gaming system 10 displays a game including a plurality of playing cards, accepts a wager on the game, and randomly distributes the plurality of playing cards. Each of the playing cards has an associated pip status. The gaming system 10 selects a set of playing cards from the plurality of distributed playing cards, detects a winning condition in the set of selected playing cards, and provides an award to the player if the winning condition is detected in the set of playing cards. In addition, the gaming system 10 detects the winning condition if each playing card in the set of playing cards includes a predefined pip status.

A selected embodiment of the present invention will now be explained with reference to the drawings. It will be apparent to those skilled in the art from this disclosure that the following description of the embodiment of the present invention is provided for illustration only and not for the purpose of limiting the invention as defined by the appended claims and their equivalents.

FIG. 1 is a gaming apparatus 12 that may be used to play a game 14. FIG. 2 is a flowchart of a method 200 of allowing a player to play the game 14 that may be used with the gaming apparatus 12. FIG. 3 is graphic illustration of playing cards 16 that may be used with the game 14, and FIG. 4 is a graphic illustration of a suit 18 of playing cards 16 that may be used with the game 14. In the illustrated embodiment, the game 14 includes a primary game 20 and a secondary game 22. The primary game 20 is, for example, a baccarat-type game, and the secondary game 22 is a side-bet game that is based at least in part on play of the primary baccarat-type game 20.

In one embodiment, the game 14 is played on the gaming apparatus 12 with a plurality of decks of randomly-ordered physical playing cards 16. In another embodiment, the game 14 may be played on a gaming device 24, shown in FIG. 5. In the illustrated embodiment, the gaming apparatus 12 includes a gaming table 26 and a card shuffling device 28. The card shuffling device 28 receives one or more decks of playing cards 16 and shuffles the decks of playing cards 16 to generate a collection of randomly-ordered playing cards 16 for use in the game 14. The gaming table 26 includes a plurality of wagering areas 30 displayed on a gaming surface 32. Each wagering area 30 includes indicia 34 relating to associated wagering opportunities and is associated with a corresponding player. In the illustrated embodiment, the gaming table 26 includes a plurality of primary wagering areas 36 for receiving a wager associated with the primary game 20 from a player, and a plurality of secondary wagering areas 38 for receiving a wager associated with the secondary game 22.

In the illustrated embodiment, the method 200 includes displaying 202 the game 14 on the gaming table 26 including the primary game 20 and the secondary game 22, and providing 204 one or more decks of randomly-ordered physical playing cards 16. More specifically, a dealer 35 places a plurality of decks of playing cards 16 into the card shuffling device 28 which shuffles each of the decks of playing cards 16 together to generate the collection of randomly-ordered physical playing cards 16 for use in the game 14. Alternatively, the dealer 35 shuffles the playing cards together to generate the collection of randomly-ordered physical playing cards 16. In one embodiment, the dealer 35 may be a live person at a casino or similar gaming establishment. Alternatively, the dealer 35 may include a card dealing apparatus that includes the card shuffling device 28, a card distributing device, and a controller that includes a processor configured to perform the method 200 as described herein.

The method 200 also includes receiving 206, by the dealer 35, a first wager, i.e. a primary wager, from at least one player 37, and a second wager, i.e. a side wager, from the player 37. The primary wager is associated with the outcome of the primary game 20 and is displayed in the corresponding primary wagering area 36 associated with the player 37. The side wager is associated with the outcome of the secondary game 22 and is displayed in the corresponding secondary wagering area 38 associated with the player 37. Upon receiving the primary and secondary wagers from the players, a plurality of playing cards 16 is distributed 208 at the gaming table 26 from the decks of randomly-ordered playing cards 16. More specifically, the dealer 35 distributes 210 a first hand, i.e. a Player hand 40 including one or more playing cards 16 from the plurality of playing cards 16, and distributes 212 a second hand, i.e. a Banker hand 42 including one or more playing cards 16 from the plurality of playing cards 16. The dealer 35 then determines 214 an outcome of the primary game 20 based on the playing cards included in the Player hand 40 and the Banker hand 42, and settles 216 the primary wagers received from the players by either awarding a payout amount to the players based on the outcome of the primary game 20 or collecting the primary wager.

In the illustrated embodiment, during play of the primary game 20, the dealer 35 initially distributes the Player hand 40 including two playing cards 16, and the Banker hand 42 including two playing cards 16. The dealer 35 determines the value of the Player hand 40 and the Banker hand 42 based on the value of the playing cards 16 including the corresponding Player hand 40 and Banker hand 42. For example, in the primary game 20, playing cards 2-9 are worth face value, 10s and face cards (J, Q, K) are worth zero, and Aces are worth 1 point. The dealer 35 determines the value of each hand by adding the sum of all playing cards included in the associated hand, with the value of the hand being no greater than 10 points. More specifically, the dealer 35 determines the sum of the playing cards included in the hand and ignores the tens digit in the added sum to determine the value of the hand. For example, a hand including a 3-card and a 4-card is worth 7 points (3+4=7). A hand including a 5-card and a 7-card is worth 2 points (5+7=12=2), with the tens digit ignored in the sum because the sum total is greater than 10. A hand including a 4-card and 6-card is worth zero points (4+6=10=0), with the tens digit ignored in the sum because the sum total is equal to 10. The highest score that can be achieved in a corresponding hand is 9-points (e.g. a hand including a 4-card and 5-card, a hand including a 10-card and 9-card, or a hand including an Ace and an 8-card, etc).

In the illustrated embodiment, the dealer 35 distributes an initial deal of the playing cards such that the Player hand 40 and the Banker hand 42 include two playing cards 16. In addition, the dealer 35 distributes the cards face down, one to the Player hand 40 first, then one to the Banker hand 42, another to the Player hand 40, then another card to the Banker hand 42. Both cards in each hand are then turned over and the dealer 35 determines the value of the Player hand 40 and the Banker hand 42. Based on the initial deal, the dealer 35 then determines if further playing cards are to be distributed to the Player hand 40 or the Banker hand 42. Depending on the two hands, the Player hand 40 and/or the Banker hand 42 may receive a single additional card to complete the deal.

For example, if either the Player hand 40 or the Banker hand 42 achieves a total of 8 points or 9 points on the initial deal (known as a ‘natural’), no further cards are dealt. If not, play proceeds as follows: if the Player hand 40 has an initial total value of 0-5 points, the Player hand 40 receives an additional third playing card to complete the Player hand 40. In addition, if the Player hand 40 initially includes a total of 6 or 7 points, the Player hand 40 does not receive a third card.

The dealer 35 then determines whether the Banker hand 42 receives an additional playing card based on the value of the Player hand 40, on whether the Player hand 40 received a third playing card, and/or on the value of the third playing card distributed to the Player hand 40. If the Player hand 40 did not receive a third card, the Banker hand 42 receives an additional card if the value of the initial Banker hand 42 is 0-5 points, and the Banker hand 42 does not receive an additional card if the value of the initial Banker hand 42 is 6-7 points. In addition, if the third card distributed to the Player hand 40 is a 2-card or 3-card, the Banker hand 42 receives a third card if the initial value of the Banker hand 42 is between 0-4 points, and the Banker hand 42 does not receive a third card if the Banker hand value is between 5-7 points. Moreover, if the Player hand 40 third card is a 4-card or a 5-card, the Banker hand 42 receives a third card if the Banker hand value is between 0-5 points, and the Banker hand 42 does not receive a third card if the Banker hand value is between 6-7 points. If the Player hand third card is a 6-card or a 7-card, the Banker hand 42 receives a third card if the Banker hand value is 0-6 points, and the Banker hand 42 does not receive a third card if the Banker hand value is 7 points. If the Player hand third card is an 8-card, the Banker hand 42 receives a third card if the Banker hand value is 0-2 points, and the Banker hand 42 does not receive a third card if the Banker hand value is 3-7 points. If the Player hand third card is one of an Ace, a 9-card, a 10-card, or a face-card, the Banker hand 42 receives a third card if the Banker hand value is 0-3 points, and the Banker hand 42 does not receive a third card if the Banker hand value is 4-7 points.

In the illustrated embodiment, the hand having the highest total value is determined to be the winner of the primary game 20. Moreover, each primary wager is associated with the Player hand 40, the Banker hand 42, or a tie result. More specifically, the dealer 35 may receive a primary wager associated with the Player hand 40 having the highest value, associated with the Banker hand 42 having the highest value, or associate with the Player hand 40 and the Banker hand 42 having the same value, i.e. a tie result. The dealer 35 determines the outcome of the primary game 20 and settles the received primary wagers based on the results associated with the primary wagers and the primary game outcome. Many variations to the above described general play of a baccarat-type game fall within the scope of the present invention. Such baccarat-type games are well-known in the art, and are therefore not further discussed.

Referring to FIGS. 3 and 4, in the illustrated embodiment, the game 14 includes one or more decks of playing cards 16. Each deck of playing cards 16 includes 4 suits 18 of cards. Each suit 18 of playing cards 16 includes an Ace-card 44, 9 number-cards 46, and 3 picture-cards 48. The number-cards 46 include a 2-card 50, 3-card 52, 4-card 54, 5-card 56, 6-card 58, 7-card 60, 8-card 62, 9-card 64, and 10-card 66. The picture-cards 48 include a Jack-card 68, a Queen-card 70, and a King-card 72. Each playing card 16 includes a display region 74 having a substantially rectangular shape 76 including central portion 78 extending along a longitudinal axis 80, a first side portion 82 adjacent the central portion 78, an opposite second side portion 84 adjacent the central portion 78. The display region 74 also includes a top portion 86 and a bottom portion 88 that are orientated with respect to a transverse axis 90 that is substantially perpendicular to the longitudinal axis 80. Each playing card 16 also includes at least one value index symbol 92 that is indicative of the relative value of the playing card 16. In the illustrated embodiment, each playing card 16 includes two value index symbols 92 including a first value index symbol 92 positioned in the top portion 86 and a second value index symbol 92 positioned in the bottom portion 88. In addition, at least some of the playing cards 16 include one or more pip symbols 94 that are displayed in the display region 74. For example, the Ace-card 44 includes one pip symbol 94 displayed in the display region 74, and the number-cards 46 include a corresponding number of pip symbols 94 displayed in the display region 74. In addition, each number-card 46 includes a pip symbol 94 having a pip suit 96 that is indicative of the associated suit 18 of playing cards 16. For example, the pip suit 96 may be a heart symbol (shown in FIGS. 3 and 4), a spade symbol, a clover symbol, a diamond symbol, and/or any symbol associated with a suit of playing cards.

In the illustrated embodiment, each playing card 16 includes a predefined pip status 98. The pip status 98 includes an appearance of a pip symbol 94 in the display region 74, a pip suit 96, an arrangement of pip symbols 94 in the display region 74, and/or no pip symbols 94 being displayed in the display region 74. In the illustrated embodiment, each number-card 46 includes a plurality of pip symbols 94 orientated in a predefined pip symbol arrangement 100 that is indicative of the associated playing cards 16.

In the illustrated embodiment, the pip symbol arrangement 100 may include a pip point 102, a center pip 104, pip legs 106, two-sided pip legs 108, three-sided pip legs 110, and/or four-sided pip legs 112. A playing card 16 having pip points 102 includes a pip symbol 94 being displayed along the central portion 78 and in the top portion 86 and the bottom portion 88 of the card 16. For example, the 2-card 50 and the 3-card 52 each have a pip point 102 including a pip symbol 94 displayed along the central portion 78 and in the top and bottom portions 86 and 88 of the card 16, respectively. The center pip 104 includes one or more pip symbols 94 displayed in the central portion 78 of the playing card 16 along the longitudinal axis 80. For example, the Ace-card 44, the 3-card 52, 5-card 56, 7-card 60, 8-card 62, 9-card 64, and 10-card 66 each have center pips 104. In addition, the 2-card 50 does not have a center pip 104. The pip legs 106 include one or more pip symbols 94 being displayed in the first and second side portions 82 and 84 of the display region 74. The pip symbols 94 are displayed in a pair of columns 114 orientated with respect to the longitudinal axis 80. In addition, pip legs 106 also includes a pair 116 of pip symbols 94 being displayed in the top and bottom portions 86 and 88. For example, the 4-card 54, 5-card 56, 6-card 58, 7-card 60, 8-card 62, 9-card 64, and 10-card 66 each have pip legs 106.

The two-sided pip legs 108 includes 2 pip symbols 94 displayed in each column 114. The three-sided pip legs 110 includes 3 pip symbols 94 being displayed in each column 114. The four-sided pip legs 112 includes 4 pip symbols 94 being displayed in each column 114. For example, the 4-card 54 and the 5-card 56 each include two-sided pip legs 108, the 6-card 58, 7-card 60, and 8-card 62 each include three-sided pip legs 110, and the 9-card 64 and the 10-card 66 each include four-sided pip legs 112. In the illustrated embodiment, each picture-card 48 includes a frame 118 having a paint line 120 extending across a portion of the display region 74, and a face 122 displayed within the frame 118. The picture-cards 48 do not include a pip symbol 94 and, accordingly, have a pip status 98 of no pip symbol 94.

During play of the game 14, the dealer 35 selects one or more players 37 to receive the Player hand 40 and/or the Banker hand 42. The dealer 35 distributed the playing cards 16 in the Player hand 40 and the Banker hand 42 face down such that the cards 16 included in the Player hand 40 and the Banker hand 42 are not initially revealed. After each hand 40 and 42 has been distributed, the player 37 receiving the Player hand 40 displays a portion of the playing card 16 by bending each card 16 to partially reveal the pip symbols 94 displayed in the card 16. More specifically, the player 37 sequentially squeezes each portion of the card 16 to partially reveal the pip symbols 94 displayed with the card 16 to determine the pip status 98 of the cards 16 in the Player hand 40 and the Banker hand 42. Alternatively, the dealer 35 may sequentially reveal the pip symbols 94 displayed with the associated playing card 16. In the illustrated embodiment, the player 37 will squeeze the top portion 86 of the card 16 first to reveal any pip symbols 94 displayed in the top portion 86, and then will rotate the card 16 and squeeze the side portion 82 to reveal any pip symbols 94 displayed in the side portion 82. By sequentially revealing the pip symbols 94 displayed with the card 16, the pip status 98 and the associated card value may be determined.

For example, in one embodiment, during game play, the side portion 82 of each card 16 in a hand is displayed to reveal a portion of the pip status 98 associated with each card 16. Moreover, the first card in a hand is squeezed to reveal the pip symbols 94 displayed in first card side portion 82, which identifies the card as being a picture-card 48, or one of two or three card values. Next, the second card in the hand is squeezed to reveal the pip symbols 94 displayed in the second card side portion 82. Certain combinations of pip status 98 are desirable and some are not. For example, squeezing two picture cards results in a hand value of zero points, and is not a good result. Squeezing a picture card and a card including a three-sided pip leg 110 is indicative of a possible card total 6, 7 or 8 points. However, if each card includes two-sided pip legs 108, the card total may be 8 points (4-card and 4-card), 9 points (4-card and 5-card), or 0 points (5-card and 5-card). Next, the top portion 86 of each card 16 is displayed to determine the pip status 98 of the associated card. Once the pip symbols 94 on the side portion 82 are known, the pip symbols 94 displayed along the central portion 78 determine the value of the card 16. For example, if a card including a four-sided leg 112 is opened from the top portion 86, a center pip 104 displayed below the first pair of pip symbols 94 indicates a 10-card 66, and a center pip 104 displayed in the middle of the central portion 78 indicates a 9-card 64. Similarly, a card having a three-sided pip leg 110 and at least one center pip 104 indicates the card must be the 7-card 60 or the 8-card 62, whereas an absence of a center pip 104 indicates the 6-card 58 or the 7-card 60.

In the illustrated embodiment, the outcome of the secondary game 22 is determined 218 as a function of the pip status 98 displayed in one or more of the playing cards 16 distributed in the Player hand 40 and/or the Banker hand 42. More specifically, the method 200 includes detecting 220 a winning condition in the plurality of playing cards 16 distributed during the primary game 20, and settling 222 the side wager received from the player 37 based on the outcome of the secondary game 22 by either awarding a payout amount to the player 37 in response to detecting the winning condition or collecting the side wager. In the illustrated embodiment, the winning condition is defined as each playing card 16 of a predefined set of playing cards having a predefined pip status 98. In addition, the predefined pip status 98 includes one of a pip suit 96, a pip point 102, a center pip 104, pip legs 106, two-sided pip legs 108, three-sided pip legs 110, four-sided pip legs 112, no center pip 104, and no pips 94 being displayed in each playing card 16 included in the predefined set.

For example, in one embodiment, the predefined set of playing cards includes the last card distributed in the Banker hand 42 and each of the playing cards 16 distributed in the Player hand 40. During the primary game 20, if the Banker hand 42 receives a third card, the winning condition for the secondary game 22 is detected if the third card in the Banker hand 42 and each card in the Player hand 40 includes the same pip status 98.

In the illustrated embodiment, the method 200 also includes selecting 224 the Player hand 40 or the Banker hand 42, such that the predefined set of playing cards includes each playing card 16 included in the selected hand. For example, upon receiving the side wager from the player 37, the dealer 35 receives a player's selection indicative of the Player hand 40 or the Banker hand 42 to be associated with the side wager. If the player 37 selects the Player hand 40, the winning condition is be detected if each playing card 16 included in the Player hand 40 has the same pip status 98. Similarly, if the player 37 selects the Banker hand 42, the winning condition is detected if each card 16 distributed to the Banker hand 42 includes the same pip status 98. In one embodiment, if the primary game 20 includes a third card distributed to the Player hand 40 and/or the Banker hand 42, the predefined set includes each card in the selected hand and the third card distributed to the non-selected hand. For example, if the player 37 selects the Player hand 40, the winning condition is met if each playing card 16 in the Player hand 40 and the third card distributed in the Banker hand 42 includes the same pip status 98. Similarly, if the Banker hand 42 is selected, the winning condition is detected if each playing card in the Banker hand 42 and the third card distributed in the Player hand 40 include the same pip status 98. Moreover, in one embodiment, the winning condition may be detected if the selected hand includes three playing cards 16. For example, if the player 37 selects the Player hand 40, the winning condition is detected if the dealer 35 distributes a third playing card to the Player hand 40 and each playing card in the Player hand 40 has the same pip status 98.

In one embodiment, the method 200 may include determining 226 if an outcome of a primary game 20 includes a winning hand, and detecting 228 the winning condition if the selected hand matches the winning hand and the selected hand includes the predefined pip status 98. For example, in the illustrated embodiment, the player 37 selects either the Player hand 40 or the Banker hand 42. The dealer 35 distributes the playing cards 16 to the Player hand 40 and the Banker hand 42 and determines whether the Player hand 40 or the Banker hand 42 includes the winning hand in the primary game 20. The dealer 35 then determines if the player 37 selected hand is the winning hand and determines the winning condition to be met if the player 37 selected hand is the winning hand. For example, in one embodiment, the player 37 may select the Banker hand 42 in the primary game 20. After distributing the Player hand 40 and the Banker hand 42 in the primary game 20, the dealer 35 determines whether the Banker hand 42 or the Player hand 40 is the winning hand in the primary game 20. The dealer 35 also determines the winning condition to be met if each card 16 in the Banker hand 42 includes the same pip status 98 and the Banker hand 42 is the winning hand in the primary game 20.

In one embodiment, the dealer 35 determines the winning condition to be met if the last cards distributed to the Player hand 40 and the Banker hand 42 includes the same pip status 98. For example, the method 200 may also include distributing 230 the Player hand 40 including three cards 16 and distributing the Banker hand 42 including three cards 16 in the primary game 20. The dealer 35 then determines 232 the winning condition to be met if the Player hand third card and the Banker hand third card each include the same pip status 98.

In one embodiment, the predefined set of playing cards 16 may include each of the plurality of distributed playing cards 16 such that the winning condition is met if each distributed playing card 16 in the primary game 20 includes the same pip status 98. In addition, the method 200 may also include distributing the Player hand 40 including three playing cards and distributing the Banker hand 42 including three playing cards, and detecting 234 the winning condition if each of the three cards in the Player hand 40 and each of the three cards in the Banker hand 42 have the same pip status 98. In one embodiment, the method 200 may also include selecting the Player hand 40 or the Banker hand 42, determining if an outcome of a primary game 20 includes a winning hand, and detecting the winning condition if the selected hand matches the winning hand and each playing card in the Player hand 40 and the Banker hand 42 has the same pip status 98. In one embodiment, the method 200 may include detecting the winning condition if the outcome of primary game 20 is a tie result.

In one embodiment, the winning condition may include a first predefined set of playing cards having a first pip status and a second predefined set of playing cards having a second pip status that is different from the first pip status. For example, the winning condition may be defined as each card 16 in the Player hand 40 having the first pip status, and each playing card 16 in the Banker hand 42 having the second pip status.

In another embodiment, the secondary game 22 may be a progressive-type game that includes a progressive jackpot. The progressive jackpot increases based on the wagers placed by the players. For example, a predetermined percentage of each secondary wager is added to the progressive jackpot. In one embodiment, a predefined pip status 98 is associated with the progressive jackpot. Upon detecting the pip status 98 associated with the progressive jackpot, the dealer 35 awards the player the progressive jackpot award.

FIG. 5 is a schematic view of the gaming system 10, according to an embodiment of the present invention. FIG. 6 is a graphical display of a baccarat-type game that is displayed by the gaming system 10. In the illustrated embodiment, the gaming system 10 is configured to execute the method 200 to enable a player to play the game 14. The gaming system 10 includes a gaming device 24 that includes a display device 124 for displaying a plurality of games, a user input device 126 to enable a player to interface with the gaming system 10, and a gaming controller 128 that is operatively coupled to the display device 124 and the user input device 126 to enable a player to play games displayed on the display device 124. The gaming device 24 may also include a housing 130 that is configured to support the display device 124, the user input device 126, and/or the gaming controller 128. The display device 124 and the user input device 126 are coupled to the housing 130 and are accessible by the player. In one embodiment, the gaming controller 128 is positioned within the housing 130. Alternatively, the gaming controller 128 may be separated from the housing 130, and connected to components of the gaming device 24 through a network such as, for example, a local area network (LAN), a wide area network (WAN), dial-in-connections, cable modems, wireless modems, and/or special high-speed Integrated Services Digital Network (ISDN) lines. In one embodiment, the gaming device 24 may be, for example, a video poker machine and/or a video slot machine that is installed in a casino. In another embodiment, the gaming device 24 may include a personal computer, laptop, cell phone, smartphone, tablet computer, personal data assistant, and/or any suitable computing device that enables a player to connect to gaming controller 128 to play the game 14.

In the illustrated embodiment, the display device 124 includes a display 132 including a flat panel display, such as a cathode ray tube display (CRT), a liquid crystal display (LCD), a light-emitting diode display (LED), an organic light-emitting diode display (OLED), an active-matrix organic light-emitting diode display (AMOLED), a plasma display, and/or any suitable visual output device capable of displaying graphical data and/or text to a user. Alternatively, a single component, such as a touch screen, may function as both the display device 124 and as the user input device 126. In the illustrated embodiment, the display device 124 displays a game screen 134 including indicia and/or symbols for use in a game, e.g., cards used by a card game, symbols for a keno game, roulette wheel and symbols used in a roulette game, and reels used in a reel game. The game screen 134 may include any type of game including, but not limited to, a video baccarat game, a video slot game, a blackjack game, a video poker game, or any type of game which allows a player to make a wager, play a game, and potentially provide the player an award based on an outcome of the game and a paytable. In addition, the display device 124 may display game play instructions for performing the game including, but not limited to, playing instructions, paytables, and/or any other information to enable the gaming device 24 to function as described herein.

The user input device 126 includes a plurality of input buttons 136 for transmitting a signal indicative of a player selection input to the gaming controller 128. For example, the input buttons 136 allow a player to input a wager on a game, selecting a number of rounds to be played during a gaming session, and initiate an output of the game, and dispense any accumulated gaming credits to the player.

In one embodiment, the gaming device 24 may be, for example, a video poker machine and/or a video slot machine that is installed in a casino. The video poker/slot machine may include a coin slot (not shown) for receiving coins and/or tokens deposited by the player into the gaming device 24 and/or a bill acceptor (not shown) for accepting a bill, a ticket, and/or a cash card into the gaming device 24 to enable an amount of gaming credits associated with a monetary value of the coins, tokens, bills, ticket, and/or cash card to be credited to the gaming device 24 for use in playing a game on the gaming device 24.

In the illustrated embodiment, the gaming controller 128 includes a processor 138, a database 140, a memory device 142 coupled to the processor 138 and the database 140, a credit module 144, a random-number generator 146, and a display module 148. The memory device 142 includes a computer readable medium, such as, without limitation, random access memory (RAM), read-only memory (ROM), erasable programmable read-only memory (EPROM), flash memory, a hard disk drive, a solid state drive, a diskette, a flash drive, a compact disc, a digital video disc, and/or any suitable device that enables the processor 138 to store, retrieve, and/or execute instructions and/or data.

The processor 138 executes various programs, and thereby controls other components of the gaming controller 128 according to player instructions and data accepted by the user input device 126. The processor 138 in particular executes a game program, and thereby conducts a game in accordance with the embodiments described herein. The memory device 142 stores programs and databases used by the processor 138. Moreover, the memory device 142 stores and retrieves information in the database 140 including, but not limited to, a game type, a number of playing cards associated with a game, a pip status associated with each playing card, a predefined set of playing cards, symbols displayed on each playing card, image data for producing game images and/or screens on the display device 124, and temporarily stores variables, parameters, and the like that are used by the processor 138. In addition, the memory device 142 stores indicia, playing cards weights, paytables, and/or winning combination tables which represent relationships between combinations of random numbers, combinations of pip status matches and types of awards. In one embodiment, the memory device 142 utilizes RAM to temporarily store programs and data necessary for the progress of the game, and EPROM to store, in advance, programs and data for controlling basic operation of the gaming device 24, such as the booting operation thereof.

The credit module 144 manages the amount of player's credits for use with the gaming device 24. The credit module 144 may include a plurality of player accounts, wherein each player account includes a unique player identification number and an associated amount of player credits. In one embodiment, the credit module 144 receives a unique player identification number from the player via the user input device 126, determines a corresponding player account based on the received player identification number and determines an amount of credits available for use on the gaming device 24 based on the associated player account.

The display module 148 controls the display device 124 to display various images on screens preferably by using computer graphics and image data stored in the memory device 142. More specifically, the display module 148 controls the game symbols displayed in a baccarat-type game screen displayed on the display device 124 by using computer graphics and the image data.

The random-number generator (RNG) 146 generates and outputs random numbers to the processor 138 preferably at the start of each round of the game. The processor 138 generally uses the random numbers to generate an outcome of the game. In addition, the processor 138 may use random numbers generated by the RNG 146 to determine an outcome of the primary game 20, and outcome of the secondary game 22, and if a winning condition has occurred in the outcome of the game 14, and to determine whether or not to provide an award to a player. For example, if the game is a baccarat-type game, the processor uses the RNG 146 to randomly select the plurality of playing cards for use in the baccarat-type game. Moreover, the processor 138 uses the random numbers to select the playing cards 16 being distributed in the Player hand 40 and the Banker hand 42, and compares the Player hand 40 and the Banker hand 42 to determine an outcome of the game 14.

In the illustrated embodiment, the gaming controller 128 is configured to display the game 14 on the display device 124. In one embodiment, the game 14 is a video baccarat-type game. However, it should be noted that the game 14 may be any type of game upon which a player could make a wager including, but not limited to, a slot game, a blackjack game, a video poker game, or any type of game that enables the gaming system 10 to function as described herein.

In the illustrated embodiment, the gaming controller 128 receives a signal from the user input device 126 that is indicative of a player's selection to initiate a gaming session including a wager amount and a selection of the Player hand 40, the Banker hand 42, or a tie result. More specifically, the gaming controller 128 receives a primary wager and/or a secondary wager from a player and displays the game 14 including the gaming table 26 and a plurality of playing cards 16. The gaming controller 128 displays the received primary wager in the primary wagering area 36, and displays the secondary wager in the secondary wagering area 38. In one embodiment, the gaming controller 128 also displays the outcome of a predefined number 149 of previous games to notify the player of the previous winning hands and/or tie results. In the illustrated embodiment, upon receiving the primary and secondary wagers, the gaming controller 128 displays the game 14 including the primary game 20 and the secondary game 22, and randomly selects a plurality of playing cards 16.

During play of the primary game 20, the gaming controller 128 distributes the Player hand 40 and the Banker hand 42 from the plurality of playing cards 16. The gaming controller 128 determines the value of playing cards 16 distributed in the Player hand 40 and the Banker hand 42, determines if an additional third card is to be distributed to the Player hand 40 and/or the Banker hand 42, and responsively distributes an additional third card to the Player hand 40 and/or the Banker hand 42. The gaming controller 128 also determines a value of the Player hand 40 and the Banker hand 42, determines an outcome of the primary game 20 as a function of Player and Banker hand values, and responsively settles the primary wager received from the player by either providing an award to the player based on the primary wager, the primary game outcome, and a paytable, or collecting the wager. In general, the term “award” may be a payout, in terms of credits or money. Thus, the gaming controller 128 may award a regular payout in response to the outcome of the game 14. However, it should be noted that the term award may also refer to other types of awards, including prizes, e.g., meals, show tickets, etc. . . . , as well as in-game award, such as free games, bonus symbols, and/or special game modes.

In the illustrated embodiment, during play of the secondary game 22, the gaming controller 128 determines a predefined set of playing cards 16 from the playing cards 16 distributed in the primary game 20 and detects the occurrence of the winning condition in the predefined set of playing cards 16. More specifically, the gaming controller 128 determines the winning condition to have occurred if each playing card 16 of the predefined set of playing cards has a predefined pip status 98. Upon detecting the winning condition, the gaming controller 128 provides an award to the player based on the winning condition, the received secondary wager, and a paytable.

In one embodiment, the gaming controller 128 may determine the predefined set of playing cards 16 to include the last card distributed in the Banker hand 42 and each of the playing cards 16 in the Player hand 40. In another embodiment, the gaming controller 128 may receive a user selection input indicative of a player's selection of the Player hand 40 or the Banker hand 42, and determine the winning condition to include the predefined set of playing cards 16 including each playing card 16 included in the selected hand, such that the winning condition is detected if each card 16 in the predefined set of playing cards 16 includes the same pip status 98. Alternatively, the gaming controller 128 may randomly select the Player hand 40 or the Banker hand 42 and determine the predefined set to include the randomly selected hand. In one embodiment, the gaming controller 128 may also determine the predefined set of playing cards 16 to include the last playing card 16 distributed in the non-selected hand. In addition, the gaming controller 128 may detect the winning condition if the selected hand includes three cards 16.

In one embodiment, the gaming controller 128 determines if the outcome of the primary game 20 includes a winning hand and detects the winning condition if the player selected hand matches the winning hand. The gaming controller 128 may also determine the predefined set of playing cards 16 to include the last card 16 distributed in the Player hand 40 and the last card distributed in the Banker hand 42.

In another embodiment, the gaming controller 128 may determine the predefined set of playing cards 16 to include each of the playing cards 16 distributed in the primary game 20, such that the winning condition is detected if the each distributed playing card 16 includes the same pip status 98. In addition, the gaming controller 128 may receive a player's selection indicative of the Player hand 40 or the Banker hand 42, determine if the outcome of the primary game 20 includes a winning hand, and detect the winning condition if the selected hand matches the winning hand. Alternatively, the gaming controller 128 may receive a player's selection indicative of a tie result, and detect the winning condition if the outcome of a primary game is a tie result.

In one embodiment, the gaming controller 128 defines the winning condition to include a first predefined set of playing cards 16 and a second predefined set of playing cards 16, and detects the winning condition if each playing card 16 of the first predefined set has a first pip status and each playing card 16 of the second predefined set has a second pip status that is different than the first pip status. Moreover, the gaming controller 128 may determine the first predefined set as including each playing card 16 in the Player hand 40 and determine the second predefined set as including each playing card 16 in the Banker hand 42.

FIG. 7 is a schematic view of another embodiment of the gaming system 10. In the illustrated embodiment, the gaming system 10 includes a system controller 150 and one or more gaming devices 24 that are coupled to the system controller 150. In the illustrated embodiment, the gaming devices 24 and the system controller 150 are coupled in communication with a local area network (LAN) 152. Alternatively, the gaming devices 24 and the system controller 150 may be coupled via a network such as, for example, an Internet link, an intranet, a WAN, dial-in-connections, cable modems, wireless modems, and/or ISDN lines. In one embodiment, the system controller 150 may be implemented by one of the gaming controllers 128 associated with a corresponding gaming device 24. In the illustrated embodiment, the system controller 150 includes a processor 154, a database 156, a memory device 158 coupled to the processor 154 and the database 156, a credit module 160, a random-number generator 162, and a display module 164. The system controller 150 is configured to perform all of the functions of the gaming controller 128 as described herein.

In the illustrated embodiment, the system controller 150 includes multiple instances of the game 14 such that each gaming device 24 may play a separate instance of the game 14 simultaneously. Alternatively, the system controller 150 enables players on one or more gaming devices 24 to simultaneously play the same game.

An exemplary technical effect of the methods, systems, and computers described herein includes at least one of (a) randomly selecting a plurality of playing cards, each playing card of the plurality of playing cards having an associated pip status; (b) determining a predefined set of playing cards from the plurality of selected playing cards; (c) distributing a first hand including one or more playing cards from the plurality of playing cards; (d) distributing a second hand including one or more playing cards from the plurality of playing cards; (e) and detecting a winning condition in the plurality of distributed playing cards, the winning condition being defined as each playing card of the predefined set of playing cards having a predefined pip status.

The above-described systems and methods overcome at least some disadvantages of known gaming machines by providing a gaming system that allows a player to player a baccarat-type game that includes a side wagering game that is based on the appearance of pip symbols in the distributed playing cards. More specifically, the gaming system distributes the Player hand and the Banker hand including a plurality of cards that each have an associated pip status, and determines the pip status of each card in a predefined set of the distributed playing cards. The gaming system provides an award to the player if each playing card in the predefined set has the same pip status. By providing a gaming system that provides an award to a player based on the pip status of the distributed playing cards, the player's expectation for achieving a win is increased and the enjoyment of the game is improved. Thus, the amount of time that the game is played by patrons of a gaming establishment is thereby increased.

Exemplary embodiments of a gaming system and a method of allowing a player to play a baccarat-type game on a gaming machine are described above in detail. The system and method are not limited to the specific embodiments described herein, but rather, components of the system and/or steps of the method may be utilized independently and separately from other components and/or steps described herein. For example, the gaming system may also be used in combination with other gaming systems and methods, and is not limited to practice with only the gaming system as described herein. Rather, an exemplary embodiment can be implemented and utilized in connection with many other gaming system applications.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the present invention can be obtained from a study of the drawings, the disclosure, and the appended claims. The invention may be practiced otherwise than as specifically described within the scope of the appended claims. It should also be noted that the steps and/or functions listed within the appended claims, notwithstanding the order of which steps and/or functions are listed therein, are not limited to any specific order of operation.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A method of providing a wagering game at a gaming table comprising the steps of:
displaying a game on the gaming table, the gaming table including one or more wagering areas and indicia relating to associated wagering opportunities;
providing one or more decks of randomly-ordered physical playing cards;
receiving a side wager from a player;
distributing a plurality of playing cards at the gaming table from the one or more decks of playing cards, each playing card of the plurality of playing cards having an associated pip status, the plurality of distributed playing cards including a predefined set of playing cards;
detecting a winning condition in the plurality of distributed playing cards, the winning condition being defined as each playing card of the predefined set of playing cards having a predefined pip status; and
settling the wager received from the player by either awarding a payout amount to the player in response to detecting the winning condition or collecting the wager.

2. A method in accordance with claim 1, wherein the predefined pip status includes one of a pip suit, a pip point, a center pip, pip legs, two-sided pip legs, three-sided pip legs, four-sided pip legs, no center pip, and no pips.

3. A method in accordance with claim 1, wherein the wagering game is a progressive game.

4. A method in accordance with claim 1, further comprising the steps of:
distributing a player hand including one or more playing cards from the plurality of playing cards; and
distributing a banker hand including one or more playing cards from the plurality of playing cards.

5. A method in accordance with claim 4, wherein the predefined set of playing cards includes the last card distributed in the banker hand and each of the playing cards in the player hand.

6. A method in accordance with claim 4, the method further includes the step of selecting one of the player hand and the banker hand, the predefined set of playing cards including each playing card included in the selected hand.

7. A method in accordance with claim 6, wherein the predefined set of playing cards also includes the last playing card distributed in the non-selected hand.

8. A method in accordance with claim 6, further comprising the step of detecting the winning condition if the selected hand includes three cards.

9. A method in accordance with claim 6, further comprising the steps of:
determining if an outcome of a primary game includes a winning hand; and
detecting the winning condition if the selected hand matches the winning hand.

10. A method in accordance with claim 4, wherein the predefined set of playing cards includes the last card distributed in the player hand and the last card distributed in the banker hand.

11. A method in accordance with claim 10, further comprising the steps of:
distributing the player hand including three cards; and
distributing the banker hand including three cards.

12. A method in accordance with claim 4, wherein the predefined set of playing cards includes each of the plurality of distributed playing cards.

13. A method in accordance with claim 12, further comprising the steps of:
distributing the player hand including three playing cards; and
distributing the banker hand including three playing cards.

14. A method in accordance with claim 12, further comprising the steps of:
selecting one of the player hand and the banker hand;
determining if an outcome of a primary game includes a winning hand; and
detecting the winning condition if the selected hand matches the winning hand.

15. A method in accordance with claim 12, further comprising the step of detecting the winning condition if the outcome of the primary game is a tie.

16. A method in accordance with claim 4, wherein the winning condition includes a first predefined set of playing cards and a second predefined set of playing cards, each playing card of the first predefined set of playing cards having a first pip status, each playing card of the second predefined set of playing cards having a second pip status that is different than the first pip status.

17. A method in accordance with claim 16, wherein the first predefined set of playing cards includes each playing card in the player hand and the second predefined set of playing cards includes each card in the banker hand.

18. A system for providing a wagering type game, comprising:
a display device;
a user input device configured to generate a signal indicative of a player selection input; and
a controller coupled to the display device and the user input device, the controller for receiving a signal indicative of a wager from a player and responsively displaying the wagering type game on the display device, for randomly selecting a plurality of playing cards including a predefined set of playing cards, each playing card of the plurality of playing cards having an associated pip status, for distributing a first hand and a second hand, each first hand and second hand including one or more playing cards from the plurality of playing cards, the controller for detecting a winning condition in the predefined set of playing cards and responsively settling the wager received from the player by either awarding a payout amount to the player in response to detecting the winning condition or collecting the wager, the winning condition being defined as each playing card of the predefined set of playing cards having a predefined pip status.

19. A system in accordance with claim 18, wherein the predefined pip status includes one of a pip suit, a pip point, a center pip, pip legs, two-sided pip legs, three-sided pip legs, four-sided pip legs, no center pip, and no pips.

20. A system in accordance with claim 18, wherein the wagering game is a progressive game.

21. A system in accordance with claim 18, wherein the predefined set of playing cards includes the last card distributed in the second hand and each of the playing cards in the first hand.

22. A system in accordance with claim 18, the controller for selecting one of the first hand and the second hand based on a player selection input, the predefined set of playing cards including each playing card included in the selected hand.

23. A system in accordance with claim 22, wherein the predefined set of playing cards also includes the last playing card distributed in the non-selected hand.

24. A system in accordance with claim 22, the controller for detecting the winning condition if the selected hand includes three cards.

25. A system in accordance with claim 22, the controller for determining if an outcome of a primary game includes a winning hand and detecting the winning condition if the selected hand matches the winning hand.

26. A system in accordance with claim 18, wherein the predefined set of playing cards includes the last card distributed in the first hand and the last card distributed in the second hand.

27. A system in accordance with claim 18, wherein the predefined set of playing cards includes each of the plurality of distributed playing cards.

28. A system in accordance with claim 27, the controller for selecting one of the first hand and the second hand based on a player selection input, for determining if an outcome of a primary game includes a winning hand, and for detecting the winning condition if the selected hand matches the winning hand.

29. A system in accordance with claim 27, the controller for detecting the winning condition if the outcome of a primary game is a tie.

30. A system in accordance with claim 18, wherein the winning condition includes a first predefined set of playing cards and a second predefined set of playing cards, each playing card of the first predefined set of playing cards having a first pip status, each playing card of the second predefined set of playing cards having a second pip status that is different than the first pip status.

31. A system in accordance with claim 30, wherein the first predefined set of playing cards includes each playing card in the first hand and the second predefined set of playing cards includes each card in the second hand.

32. A computer-implemented method of providing a wagering game, comprising one or more processors, communication devices, and data storage devices, all for facilitating the steps of:
receiving, from a communication device, a signal indicative of wager from a player;
generating, by a processor, the wagering game in response to the received wager and displaying the wagering game on a display device;
randomly selecting a plurality of playing cards, each playing card of the plurality of playing cards having an associated pip status;
determining a predefined set of playing cards from the plurality of selected playing cards;
distributing a first hand including one or more playing cards from the plurality of playing cards;
distributing a second hand including one or more playing cards from the plurality of playing cards;
detecting a winning condition in the plurality of distributed playing cards, the winning condition being defined as each playing card of the predefined set of playing cards having a predefined pip status; and
settling the wager received from the player by either awarding a payout amount to the player in response to detecting the winning condition or collecting the wager.

33. A method in accordance with claim 32, wherein the predefined pip status includes one of a pip suit, a pip point, a center pip, pip legs, two-sided pip legs, three-sided pip legs, four-sided pip legs, no center pip, and no pips.

34. A method in accordance with claim 32, wherein the wagering game is a progressive game.

35. A method in accordance with claim 32, wherein the predefined set of playing cards includes the last card distributed in the second hand and each of the playing cards in the first hand.

36. A method in accordance with claim 32, the method further includes the step of selecting one of the first hand and the second hand based on a player selection input, the predefined set of playing cards including each playing card included in the selected hand.

37. A method in accordance with claim 36, wherein the predefined set of playing cards also includes the last playing card distributed in the non-selected hand.

38. A method in accordance with claim 36, further comprising the steps of:
determining if an outcome of a primary game includes a winning hand; and
detecting the winning condition if the selected hand matches the winning hand.

39. A method in accordance with claim 32, wherein the predefined set of playing cards includes the last card distributed in the first hand and the last card distributed in the second hand.

40. A method in accordance with claim 32, wherein the predefined set of playing cards includes each of the plurality of distributed playing cards.

41. A method in accordance with claim 40, further comprising the steps of:
selecting one of the first hand and the second hand;
determining if an outcome of a primary game includes a winning hand; and
detecting the winning condition if the selected hand matches the winning hand.

42. A method in accordance with claim 40, further comprising the step of detecting the winning condition if the outcome of the primary game is a tie.

43. A method in accordance with claim 32, wherein the winning condition includes a first predefined set of playing cards and a second predefined set of playing cards, each playing card of the first predefined set of playing cards having a first pip status, each playing card of the second predefined set of playing cards having a second pip status that is different than the first pip status.

44. A method in accordance with claim 43, wherein the first predefined set of playing cards includes each playing card in the first hand and the second predefined set of playing cards includes each card in the second hand.
